(19) United States
(12) Patent Application Publication
(10) Pub. No.: US 2014/0281862 A1
(43) Pub. Date: Sep. 18, 2014

(54) SYSTEMS AND METHODS FOR EXPRESSING, SHARING AND RATING ARGUMENTS

(71) Applicant: Lucas K. Dailey, Madison, WI (US)

(72) Inventor: Lucas K. Dailey, Madison, WI (US)

(21) Appl. No.: 14/287,346

(22) Filed: May 27, 2014

Related U.S. Application Data
(63) Continuation of application No. 12/791,866, filed on Jun. 2, 2010, now abandoned.
(60) Provisional application No. 61/182,879, filed on Jun. 1, 2009.

(51) Int. Cl. G06F 17/22

(52) U.S. Cl. CPC G06F 17/2235; G06F 17/2247
USPC 715/205

(57) ABSTRACT

Arguments are formed by linking individual logical parts called Points. Points are linked when one Point depends on another to reach its conclusion. Users rate individual Points, based on criteria relevant to that Point's particular type. Users are rated based on how they rate Points relative to other users. A user's rating is then used to weight that user's Point ratings. One Point's ratings may in turn affect the ratings of connected Points. Dependant Points can be swapped when users identify Points with logically identical conclusions and indicate which Point they prefer. When users explore a topic, the relevant Points are sorted based on their ratings and the ratings of their authors. Lists of arguments can be created and publicized by users. Users can form groups that subscribe to lists of arguments. Users cross-reference their ratings with groups, lists of arguments and other users to find those they agree with.

This application claims priority as a continuation application of U.S. application Ser. No. 12/791,866 filed Jun. 2, 2010, which claims the benefit of priority to U.S. Provisional Patent Application 61/182,879, filed Jun. 1, 2009, the contents of which are hereby incorporated by reference in their entirety.

### BACKGROUND

1. Field of the Invention

This invention is directed to systems and methods that allow groups of people to create, share and score detailed analyses of complex arguments.

2. Related Art

We know when something makes sense to us. A coworker suggests a new office policy; your spouse hears of a new way to do something around the house; and you just get it. Simple. But what about the complicated issues: politics, business, investing, even everyday choices. These issues don't always have easy answers.

### SUMMARY OF THE DISCLOSED EMBODIMENTS

There are two reasons why a given issue doesn't have an easy answer, for either an individual or society. These are asymmetry of information, and difference of opinion.

We can solve the asymmetry problem by creating a system that identifies clearly structured arguments with evidence and logical conclusions. People can then learn about the parts of the issue they didn't previously know.

Differences of opinion are often combinations of differing logic systems and differing beliefs, values or preferences. We can examine opinions and get to the root preferences and value judgments they are based on. That will help make differences of opinion more clear.

This information can then be used when we have to make a decision that includes preferences and value-judgments, such as in contentious public policy. That is, we can find the popularity of the underlying preferences and value-judgments, to make the most popularly supported decision.

The core output of the system is a structured argument with two associated ratings: soundness and acceptance. An argument is the complete structure of logic and opinion necessary to move from axiomatic information and/or beliefs, to a well supported assertion. Soundness is the rating that determines whether or not an argument is logical. Acceptance shows the popularity of the least popular of the preferences and value judgments on which the argument is based. By reading an output Brian Williams could open the NBC Nightly News with the news: “Americans determined it is logical that capital punishment should be eliminated, based on beliefs and values shared by at least 70% of the population.”

This invention provides systems and methods for separating arguments into constituent parts.

This invention separately provides systems and methods for graphically structuring the connections between parts of an argument.

This invention separately provides systems and methods for separating logical conclusions from opinion.

This invention separately provides systems and methods for graphically representing the relationships between logic and opinion in an argument.

This invention separately provides systems and methods for rating the logicality of logical conclusion portions of an argument.

This invention separately provides systems and methods for rating the popularity of opinions within an argument.

This invention separately provides systems and methods for rating the popularity of parts of an argument that reach the same conclusion.

This invention separately provides systems and methods for identifying parts of one particular argument that may support or oppose the conclusion of a part of another particular argument.

This invention separately provides systems and methods for using particular parts of one particular argument to contribute to the structure of another particular argument.

This invention separately provides systems and methods for sorting similar arguments such that the most logical and/or popular arguments rise to the top.

This invention separately provides systems and methods for the ratings of constituent parts of an argument to affect the entire argument.

This invention separately provides systems and methods for providing incentives for users to honestly rate parts of an argument.

This invention separately provides systems and methods for providing disincentives for users to attempt to manipulate the ratings of parts of an argument.

This invention separately provides systems and methods for parts of an argument to be updated with more relevant opinion/logic.

This invention separately provides systems and methods for ratings to be determined for users based on the strength of their individual logical apparatus.

This invention separately provides systems and methods for arguments to be compiled in lists.

This invention separately provides systems and methods for lists of arguments to be endorsed and organized around by groups and/or individual users.

This invention separately provides systems and methods for the creation of public and private profiles of users based on their vote history, argument authorship, and personal details.

This invention separately provides systems and methods for users to find likeminded people based on their shared opinions, logical perspective, and personal details.

This invention separately provides systems and methods for polls to be displayed to user.

These systems and methodologies were initially designed to transform the political process from persuasion-based to fact-based, to create a system that will show when an idea makes sense even when it is unpopular with the very same people who power that system. This system empowers a group of people to transparently analyze and reach a conclusion on an assertion. The more people that use it the more powerful it becomes, and the more strength the conclusions carry. While it's designed to work at a national or international scale, it works just as well for small groups, or even an individual who wants to make a thorough and well structured assertion. It is collective intelligence for the 21st century.

The systems and methods that allow groups of people to create, share and score detailed analyses of complex arguments according to this invention can be implemented and deployed in various exemplary embodiments. Those various exemplary embodiments include;

An installed software program that operates at the client level, with user-generated content and user information being transferred between client(s) and server(s);

An installed web browser help object/add-on/plug-in/ etc. that operates a client within the browser, with user-generated content and user information being transferred between client(s) and server(s);

A single web page that implements all needed user interface screens, with little or no client installed software elements, with user-generated content, user information, and possible additional xml or other code to expand functionality, being transferred between client(s) and server(s);

Multiple web pages individually requested from a server, with each different screen implemented using a different web page, which may or may not need to be fully re-requested from the server each time that the user switches to that page, with user-generated content, user information, and possible additional xml or other code to expand functionality, being transferred between client(s) and server(s).

These and other features and advantages of various exemplary embodiments of systems and methods according to this invention are described in, or are apparent from, the following detailed descriptions of various exemplary embodiments of various devices, structures and/or methods according to this invention.

### BRIEF DESCRIPTION OF DRAWINGS

Various exemplary embodiments of the systems and methods according to this invention will be described in detail, with reference to the following figures, wherein:

FIG. 1 shows a first exemplary embodiment of an argument analysis graphical user interface screen according to this invention;

FIG. 2 shows in greater detail one exemplary embodiment of an argument tree portion of the argument analysis graphical user interface screen shown in FIG. 1;

FIG. 3 shows in greater detail one exemplary embodiment of an argument components portion of the argument analysis graphical user interface screen shown in FIG. 1;

FIG. 4 shows in greater detail one exemplary embodiment of a sidebar portion of the argument analysis graphical user interface screen shown in FIG. 1;

FIG. 5 shows a first exemplary embodiment of an argument creation graphical user interface screen according to this invention;

FIG. 6 shows in greater detail one exemplary embodiment of an argument tree creation portion of the argument creation graphical user interface screen shown in FIG. 5;

FIG. 7 shows in greater detail one exemplary embodiment of an argument component creation portion of the argument creation graphical user interface screen shown in FIG. 5;

FIG. 8 shows in greater detail one exemplary embodiment of a creation sidebar portion of the argument creation graphical user interface screen shown in FIG. 5;

FIG. 9 shows a first exemplary embodiment of an argument voting graphical user interface screen according to this invention;

FIG. 10 shows in greater detail one exemplary embodiment of a voting portion of the argument voting graphical user interface screen shown in FIG. 9;

FIG. 11 shows in greater detail one exemplary embodiment of a voting sidebar of the argument voting graphical user interface screen shown in FIG. 9;

FIG. 12 shows a first exemplary embodiment of a profile graphical user interface screen according to this invention;

FIG. 13 shows in greater detail one exemplary embodiment of a login update portion of the profile graphical user interface screen shown in FIG. 12;

FIG. 14 shows in greater detail one exemplary embodiment of a profile details portion of the profile graphical user interface screen shown in FIG. 12;

FIG. 15 shows in greater detail one exemplary embodiment of a profile sidebar portion of the profile graphical user interface screen shown in FIG. 12;

FIG. 16 shows a first exemplary embodiment of an author rating graphical user interface screen according to this invention;

FIG. 17 shows in greater detail one exemplary embodiment of an author rating details portion of the author rating graphical user interface screen shown in FIG. 16;

FIG. 18 is a flowchart outlining one exemplary embodiment of a process for creating arguments according to this invention;

FIG. 19 is a flowchart outlining one exemplary embodiment of a process for determining and updating a users author rating according to this invention; and

FIG. 20 is a flowchart outlining one exemplary embodiment of a process for determining if a key Point should be switched with another Point according to this invention.

### DETAILED DESCRIPTION OF EXEMPLARY EMBODIMENTS

For an argumentation system to be useful to, and thus readily used by the general public, it must be designed around six principles. First, it must allow for the separation of logic and opinion. Second, it must provide a method for users to collectively rate the logicality of the hypotheses and sub-hypotheses within an argument. Third, it must allow, and ideally obligate users to vote their preference on matters of opinion. Fourth, it must allow for arguments to be iterative. Fifth, it must be unmoderated, to remove any appearance of bias by a moderator or administrator. Finally, it must be open, i.e., it must allow anyone to contribute at any desired level.

In addition to following the six principles outlined above, the argumentation system must overcome seven hurdles to operate successfully. First, it must have systems in place to allow for duplication and allow duplicates to reconcile. Second, it must provide systems that establish a level of vote integrity that will be accepted as socially valid. Third, it must provide systems to minimize or eliminate the impact of vandalism and falsification by users. Fourth, it must be game-proof by providing systems that minimize or eliminate the effect of users attempting to manipulate of the system for personal reasons and/or gain. Fifth, it must provide systems that insure arguments maintain continued relevance despite continually changing evidence and evolving subjects and perspectives. Sixth, it must provide systems and methods that prevent a short-term but high volume of users from unduly swaying results, as can occur when a ideologue representing a minority viewpoint directs their followers

Core Functionality

Separation of Parts of an Argument

Points:

Arguments are separated into individual parts named Points. There are two types of Points: claims and assumptions. Claims represent individual steps of logical reasoning, without any obligation to provide any justification or reasons for the truth or validity of their assumptions. Assumptions represent parts of an argument that are taken as granted or true.

Arguments and Key Points:

Arguments are collections of Points that together form a conclusion though any number of levels of dependant claims and assumptions. When a claim directly relies on other Points to reach a conclusion, those directly related constituent Points are referred to as key Points of the main Point.

Argument Tree:

Argument trees are the diagrammatic graphical representation of a Point, its key Points, the key Points of those key Points and all subsequent key Points.

Argument Creation:

Arguments are created on a screen or interface that allows for Points to be composed and linked. Links are created by designating Points as key Point to a claim. Arguments and the Points from which they are composed can continue to be edited until the user brings them into the public domain by publishing them. The entire argument and its constituent Points can be published simultaneously, or individual Points can be published. Users can automatically populate the data input fields and structure of an argument by identifying a previously published Point to use as a template

Supporting/Opposing Points (Include?):

Supporting and opposing Points are Points that users identify as being in support of or in opposition to, respectively, the conclusion of the Point in question. Supporting and opposing Points do not affect the ratings of Points. Rather, their purpose is only to reinforce, or to question the Point to which they are attached.

Point Cart:

The Point cart is a persistent visually displayed portion of the graphical interface that is constantly displayed throughout the screens and interfaces of the invention. Users can add copies of desired Points to their Point cart similarly to adding items to be purchased to a shopping cart as it is used on most ecommerce websites. Users can use Points in their Point cart to; add one or more Points to a list, such as platforms; to use as a template when creating a new Point; to use to quickly access, like a user uses a website bookmark.

Rating and Sorting

Systems and methods for creating, using, reviewing, share and score detailed analyses of complex arguments according to this invention allows for the rating and sorting of Points on a number of criteria, allowing the most logical or popular conclusions and underlying claims and assumptions to rise to the top. While complex, argument systems and methods for creating, using, reviewing, share and score detailed analyses of complex arguments according to this invention avoid common pitfalls by implementing a series of processes that divorce value judgment bias and that discourage, and ideally prevent, user sabotage. Systems and methods for creating, using, reviewing, share and score detailed analyses of complex arguments according to this invention allow divergent viewpoints to reach a consensus conclusion through identifying which individual parts of a disagreement the various opinions hinge on.

User Types and ID Verification:

User are separated into three classifications; voting, non-voting, and administrator. Voting users are those who have created an account and have had their identities verified. A user's identity is verified through an automated process, such as using a credit card, a driver's license, the user's local/state/federal voter registration(s), any other acceptable method of high-confidence registration or any other method the administrators of a deployment of the invention find acceptable. Voting users have access to the full range of user features and processes. Non-voting users are those who simply use the invention without having their identity verified. Non-voting users aren't allowed to vote, and may not be allowed to create content, if the administrators of a deployment of the invention so choose. Administrators are users with special permissions to access back end settings to customize, modify, set thresholds, define parameters, and other known and unknown and later developed processes. An administrator is not required once the particular implementation or deployment is operational, but the administrator is likely to be involved in tailoring their particular implementation or deployment to suit that administrator's needs.

Soundness:

Soundness is, in various exemplar embodiments, the primary rating of claims. Soundness represents whether or not an argument is logical or sound, as determined by voting users. The soundness of a particular claim is determined by voting users based on whether or not they think the conclusion presented in that claim is logical when one assumes the key Points of that claim to be true or valid. For each claim, voting users are asked to vote on a question such as: “If you assume the key Points are true, does this claim reach a logical conclusion?” The numerical value of soundness is based, either directly or indirectly, the percentage of voting users that vote yes.

Acceptance:

Acceptance, which is short for “popular acceptance,” of a particular claim or assumption, is based on, either directly or indirectly, the net vote of voting users voting on whether or not they believe the assertion presented on that assumption or assumption to be true. For each assumption voting users are asked to vote on a question, such as: “Do you agree with this assumption?” acceptance is, in various exemplar embodiments, the primary rating of assumptions, and is, in various exemplar embodiments, the secondary rating of claims, as described below. In various exemplary embodiments or implementations or deployments of systems and methods according to this invention that use the author rating function, acceptance is the only variable that is not weighted.

Upstream/Downstream:

The ratings of Points in an argument can affect the ratings of other Points. Using the analogy of a river and tributaries, a key Point is referred to as upstream of the Point to which it contributes. Likewise a Point is downstream of its constituent key Points.

Claim Acceptance:

Claims show acceptance as one of their ratings, secondary to soundness. Claims are not themselves judged on acceptance, they only possess and acquire an acceptance rating when the have an assumption as a key Point and further upstream as an assumption to some intermediate claim. The claim takes as its acceptance rating, the lowest acceptance rating from among all of the upstream assumptions. In this way, any particular claims can show that it is dependant on the most unpopular of the underlying assumptions on which its conclusion is based.

State:

Claims are in one of three states, depending on their current soundness rating: right, wrong, or undetermined. Administrators of individual exemplary embodiments, implementations or deployments of systems and methods according to this invention can select specific threshold values for each state; In general the inventors have determined that a soundness rating of 0%-40% indicates that the voting users' consensus opinion is that the conclusion in the corresponding claim is wrong, a soundness rating of 40%-60% indicates that the voting users have not yet or are unable to reach a consensus opinion, such that the validity of the conclusion os the corresponding claim is undetermined, and, a soundness rating of 60%-100% is right. If a claim is in the “wrong” state, that claim displays a prominent indicator somewhere in its title or rating. Additionally, the prominent indicator is also displayed on all claims that lie downstream of that claim. Since an argument is only as strong as its weakest link, this indicator shows that it is based on a weak link. The “undetermined” and “right” states are not transferred to or carried forward to downstream claims. Unlike the way the acceptance rating of an assumption affects the ratings of all downstream claims, the soundness ratings of claims do not affect each other, as each claim is an individual piece of logic, where, as indicated above, its validity is divorced from the validity of its key Points by assuming that its key Points are true.

When a claim is in the “undetermined” state it's percentage vote value is hidden. This is done to help fight gaming. Also, there may be an algorithmic requirement that measures and insures enough total views, total votes, and votes over time have occurred before a newly created Point is allowed to leave the “undetermined” state. This tends to help us prevent small groups of focused users from giving an unscrutinized Point the perception that the voting users reached a consensus.

Competing Points:

Competing Points are Points identified by voting users have identified as having logically identical conclusions. Voting users can vote on whether or not a Point is competing with another Point, regardless of which type of Point either Point is. Each Point has a unique list of Points that voting users have identified as competing (and, by implication, not competing.)

Favor:

The “favor” rating shows which Point, among a set of competing Points, the voting users think best presents or captures the common conclusion. In various exemplary embodiments, voting users each grant a single vote to one Point among the competing Points. The competing Points are then ranked in order of total votes, represented by relative place ranking; 1^{st}, 2^{nd}, 3^{rd}, etc. When a claim has a key Point, if, at any time, that key Point also has a competing Point, and that competing Point reaches a higher level of Favor, the newest “most favorable” Point becomes a key Point in that claim, replacing the previously “most favorable” Point it competes with. In various exemplary embodiments, the newest “most favorable” claim must also meet the threshold percentage of voting user support for the selected by the administrator of that exemplary embodiment, implementation or deployment. This technique allows for Points to be updated with key Points that represent new or updated information. In turn, this allows for continued relevance of the main Point. In various exemplary embodiments the original (and now replaced) key Point remains the Point that defines the list of competing Points for that key Point slot. Doing this tends to insure that the original intent of the original (and now replaced) key Point is not lost or degraded over subsequent replacement cycles.

Author Rating:

In various exemplary embodiments, the administrators of an exemplary embodiment, implementation or deployments may choose to implement features and methods relating to author rating. Author rating is the rating given to individual users, and is determined by comparing by all comparing all of their votes on the soundness of claims and identification of competing Point with the current weighted majority results. Broadly, when the voting user has voted with the weighted majority, that voting user's author rating increases. In contrast, when the voting user has voted against the weighted majority that voting user's author rating decreases. When implemented by administrators of an exemplary embodiment, implementation or deployment, the author rating is used to weight all of the votes and ratings of the voting users, with the exception of their votes on the acceptance of assumptions. The author rating allows voting users who, in aggregate, vote most often with the majority on matters of logic to be given a stronger voice on matters of logic than those who do not.

Administrators of an exemplary embodiment, implementation or deployment may also allow voting users to (modestly) increase their author rating when that voting user: authors Points, fills out additional personal details, receives endorsements from peers, performs a certain number of actions (such as voting on competing Points), maintains earns or obtains a high soundness rating on Points that voting user has authored, and/or any other behaviors and/or actions the, administrators want to encourage.

Ordering and Analysis

Point Listings:

Whenever a list of Points is shown to a user, such as in the response to a keyword search, that user can select the order in which the listed Points are arranged. That is, a user may adjust the display order based on a variety of criteria, such as the author rating of each Point's author, the soundness and/or acceptance rating of each Point, Favor rating of each Point, the number of votes of each Point, number of views of each Point, view-to-vote ratio of each Point, and/or any other blend of these and/or any other known or later developed factors.

Platforms:

Voting users can create platform, which are simply lists of Points that one or more users assemble. The creator of a Platform can assign ownership rights to one or more others users. Each Platform includes at least a name, a description, and a list of Points.

Parties:

A party is a group of users, similar to the use of the word “group” in social networking sites, that has at least one associated platform it endorses. Parties may have as many Platforms as they would like, and can restrict membership based on whether or not a User has a specific percentage of votes in alignment with a platform. In this way, groups of likeminded users can meet each other and organize around clearly shared ideologies, positions, or preferences. Each party includes of at least a name, a descriptions, a list of members and a list of endorsed platforms.

User Profiles:

Each voting user has a series of public pages or user interfaces or screens that are automatically generated for that user. These automatically generated public pages or user interfaces or screens are used to that list all of the votes the user has made, all of the Points created, as well as to store, organize and/or display any biographical information the user has supplied. The types of biographical information the user is able to supply is typical of that collected by contemporary social networking sites. Users are able to control the public visibility of most sections of their user pages or user interfaces or screens.

User Start Page:

Each voting user has a series of private pages or user interfaces or screens that are automatically generated for that user. These private pages or user interfaces or screens show, in chart form, each of the votes that user has cast and Points the user has have authored. Among the data that can be included in these charts are the ratings of each Point authored by and/or voted on, by that user, and the change in value since the last viewing, or other period of time determined by the administrators.

Author Rating Details Page:

For any exemplary embodiments, implementations or deployments that implement the Author Rating features and functions, each voting user also has an Author Rating page or user interface screen that lists some or all of the votes the user has made that affect their author rating. In some exemplary embodiments, implementations or deployments, the author rating page or user interface screen can also indicate those areas in which a user can increase the user's author rating.

Find-People-Like-Me Button:

Voting users can access pages or user interface screens that cross reference the votes of the user with the votes of some or all other users, platforms and/or parties, and that display one or more lists of those users, platforms and/or parties that best match their votes. In this way, users can find and connect with, like-minded people and organizations. In some exemplary embodiments, implementations or deployments voting users are also able to narrow the resultant lists by criteria, such as age, sex, marital status, location, and/or other known and/or later developed criteria, including other common social networking user criteria (in the case of users) and such as number of members, number and/or identity of supporters, and/or any known and/or later-developed criteria, including other common social networking group criteria, in the case of platforms and parties.

Polls:

In some exemplary embodiments, implementations or deployments Points can be used as the basis for one or more as poll questions by pollsters and/or other organizations. The Point rating processes identify Points as being logical (through soundness and favor) and popular (through acceptance and favor). While these systems and methods help educate and reveal areas of disagreement, they also function as more traditional online polling.

These features, which can be provided in various exemplary embodiments of the systems and methods for expressing, sharing, and rating arguments according to this invention, will be described in greater detail with respect to FIGS. 1-17. In particular, FIGS. 1-17 describe one exemplary embodiment of a graphic user interface 1000 that includes a number of distinct graphic user interface screens 1010, 1020, 1030, 1040 and 1050. The user can navigate between particular graphic user interface screens using menus, links, and other known and unknown and later developed navigation methods.

FIG. 1 shows one exemplary embodiment of an argument analysis graphical page or user interface screen 1010 according to this invention. The argument analysis graphical page or user interface screen 1010 comprises three parts: an argument tree portion 1100, an argument components portion 1200, and a sidebar portion 1300.

FIG. 2 shows one exemplary embodiment of the argument tree 1100 portion. The argument tree portion 1100 includes an argument tree 1101, an instance of the login portion 1110, an anchor portion 1120, and a logo 1102. The logo 1102 is used to identify the particular sponsor or this implementation or deployment of an argument analysis system and method according to this invention.

As shown in FIG. 2, the argument tree graphically represents the relationship between the Points that lead up to the main Point 1140 of the argument 1140. The individual key Point dependency connections between the main Point 1140 and its three key Points 1150 are shown by the dependency links 1142. The main Point 1140 relies on three first level key Points 1150, which, as illustrated by their dependency links 1152, rely on a number of second level key Points 1160. The second level key Points 1160, as illustrated by their dependency links 1162, rely on a number of third level key Points 1170, and so on. A third level key Point 1174 is linked by 1172 to one or more fourth level key Points. The hidden Points can be revealed by selecting one of the hidden level buttons 1102-1106. Arguments can have an essentially unlimited number of dependent levels after the first or key Point level. Rather than arbitrarily reducing the display size of the Points to allow all levels to be displayed, one, some or even all of the levels upstream of the first or key Points level can be hidden from the user until and unless the user wishes to view them. This can be implemented using the hidden level buttons 1104. Upon selecting one of the hidden level buttons 1104, one or more of the first-third levels are hidden and are replaced with one or more of the hidden fourth and beyond levels, along with hidden buttons 1104 usable to access the hidden first-third levels and, if necessary, further hidden upstream levels.

As shown in FIG. 2, the main Point 1140 relies on key Points 1154, 1156, 1158. The key Point 1158 in turn relies on its key Point 1168, while the main key Point 1154 relies in turn on its key Points 1164 and 1166, while the second level key Point 1164 in turn relies on one or more hidden key Points, which can be revealed by selecting the button 1106. The second level key Point 1166 relies on its key Points 1174 and 1176, while the second level key Points relies on one or more hidden key Points, which can be revealed by selecting the button 1106. Similarly, the second level key Point 1168 in turn relies on one or more hidden key Points that can be revealed by selecting the button 1102. The third level key Point 1174 relies on one or more hidden key Points that can be revealed by button 1104.

As shown in FIG. 2, the login portion 1110 has four buttons. The “Home” button 1114 takes the user to the home page or user interface screen. The “Your Profile” button 1113 takes the user to their individualized profile page or user interface screen. The “Polls” button 1112 takes the user to the Polls interface. The “Log Out” button 1114 takes the user to the home page or user interface screen and logs them out.

As shown in FIG. 2, an anchor portion 1120 is used to allow the argument tree 1110 to shift when a new anchor Point is selected. The “Argument Tree Anchor Point” text string 1121 helps identify the function of the anchor portion 1120. The currently selected anchor Point is always located in main Point position 1140. In the exemplary embodiment shown in FIG. 2, the anchor Point 1140 is also the active Point 1130, as indicated by the outline 1130 and the “Active” text string 1132. The active Point 1130 is the last Point in the argument tree 1110 selected by the user. The data for the selected active Point 1130 is used to populate the argument components portion 1200 and the sidebar portion 1300. As the active Point 1130, the main Point 1140 will also be displayed in the anchor portion in position 1122. To change the anchor Point 1140 and thus shift the argument tree, the user clicks a Point on the argument tree, and then clicks the “Make Anchor” button 1127 within the anchor portion 1120. In the exemplary embodiment shown in FIG. 2, the active Point 1130 is already the anchor Point 1140, and thus the “Make Anchor” button 1127 is grayed out, rendering it nonfunctional. If a Point was active that was not already the anchor, the “Make Anchor” button 1127 would be displayed using the same visual aesthetic of other functioning buttons.

As shown in FIG. 2, all Points in the argument tree portion are displayed similarly to the Point 1122, that is, in the argument tree portion 1100, each Point as displayed, includes that Point's name, its soundness rating 1124, its acceptance rating 1125, its favor rating 1126 and a Point type icon 1123 identifying the type of Point with a color and single letter abbreviation.

FIG. 3 shows one exemplary embodiment of an argument components portion 1200. The argument components portion 1200 contains a title portion 1210, a key Points portion 1220, a supporting Points portion 1230, a body portion 1240, a critiques portion 1250, a references portion 1260, and a related Points portion 1270.

As shown in FIG. 3, the title portion 1210 contains a title 1211, a subtitle 1214, a Point type icon 1213 with textual reinforcement below it, the authors name 1211, and the concept brief 1217 below the “Concept Brief” title 1216. The concept brief 1217 is a short, character limited summary of the Point.

As shown in FIG. 3, below the “Key Points” title 1222, the key Points portion 1220 contains a list of all of the first level key Points 1224 with their respective ratings and Point type icon indicator 1223. In the exemplary embodiment shown, the user has toggled the show concept brief button 1283. When the show concept brief button 1283 for a given key Point is activated the height of the key Points list expands and displays the key Point concept brief 1226 for that key Point. When activated, the text of the show concept brief button changes from “Show Concept Brief” to “Hide Concept Brief” to indicate the changed function of the button 1283. When the show concept brief button 1283 has been toggled, activating it a second time will reverse the effects, again switching the text displayed for the concept brief is removed and the key Point list shrinks back down.

As shown in FIG. 3, below the “Supporting Points” title 1232, the supporting Points portion 1230 contains a list of all of the supporting Points 1234, with their respective ratings and Point type indicator icons 1233. It should be appreciated that all Points listed in the argument components portion 1200 will have their associated ratings displayed, such as the ratings of the supporting Point 1234 with its rating group 1280. The rating group 1280 contains the soundness rating 1288, the acceptance rating 1286, and the favor rating 1284. The supporting Point list of Points also includes a show concept brief button 1282.

As shown in FIG. 3, the body portion 1240 contains the body of text 1242 of the Point 1140, with periodic line numbering 1244. The amount of text in the body of text 1242 of the Point 1140 is the primary text of the Point 1140. In particular, the body of text 1242 provides space where the author can present his/her full argument. The body of text 1242 is not character limited. In various exemplary embodiments, to aid in references, particularly for users that leave comments relating to particular parts of the text, a subtle line numbering 1244 is indicated in the body of text 1242, with a number displayed every 5 lines as shown.

As shown in FIG. 3, in the Critiques portion 1150, below the “Critiques” title 1252, some or all of the critiques 1254 of the Point 1140 provided by individual users are listed. Each critique 1254 displays the title of the critique 1254, the critique author's name 1256, the critique author's rating 1257, and a “Show Critique” button 1258. The show critique button 1258 function similarly to the show concept brief buttons 1282, except they display the body of the critique instead of the concept brief of a Point. The list of critiques 1254 is ordered by the critique author's rating or by any other known or later-developed ordering criterion. In various exemplary embodiments, users create the critiques 1254 using a comment system, not shown, such as Disqus, that is embedded into the argument component portion 1200. In various exemplary embodiments, the critiques 1254 can also have some form of integrated rating system to allow users to rate the individual critiques. This could take the form of a “Like” button, thumbs-up and thumbs-down buttons, and/or any other known or unknown rating method.

As shown in FIG. 3, in the references portion 1260, below the title “References” 1262, the listed references 1264 each include an identifying text string and a hyperlinks to supporting information identified by the Point author. The references 1264 are an important component, in that they can provide direct links to data, reports, or other significant information that supports the conclusion of the Point 1140.

As shown in FIG. 3, in the related Points portion 1270, below the “Related Points” title 1272, a number of related Points 1274 are listed. Each related Point 1274 is displayed with its ratings 1284-1288, a Point type icon 1273 and a show concept brief button 1282. The related Points 1274 are those Points that users have previously identified as having some meaningful relationship to the main Point 1140 of the argument, but that may not validly fit into the supporting, opposing and/or competing Point categories. The related Points are identified using the same method as supporting, opposing and competing Points described below. The related Points 1274 are listed in order of the number or strength of the votes each related Point has accrued in being identified as related to the main Point 1140, using any voting method.

FIG. 4 shows one exemplary embodiment of the sidebar portion 1300. The sidebar portion 1300 contains a details portion 1310, a Point cart portion 1320, a competing Points portion 1330, a critique quotes portions 1340, and a polling portion 1350.

As shown in FIG. 4, the details portion 1310 contains a statistics portion 1315, the ratings 1312-1316, and a number of primary interaction buttons 1313 and 1318. The statistics portion 1315 lists the most relevant statistics to the Point 1140, including the total number of times the Point 1140 has been viewed, the total number of votes on the primary question of the Point 1140, and the date the Point 1140 was published. If the Point 1140 is a claim, the statistics portion 1315 will display what state the claim is currently in. The details portion 1310 displays the individual ratings of the Point 1140, including the soundness rating 1312, the acceptance rating 1314 and the favor rating 1316. The primary rating (soundness for claims; acceptance for assumptions) may have some additional visual emphasis added that increase its prominence, such as a larger font size for rating 1312. The details portion 1310 displays a vote button 1313 and an add to cart button 1318. When a user clicks on the vote button 1313, that user is taken to the argument voting page or graphical user interface screen. When a user clicks on the add to cart button 1318 the active Point is added to the Point cart 1320, described below. The details portion 1310 also contains a user vote status indicator 1311 that informs a particular user whether or not that user has have already voted on the active Point 1140. In the exemplary embodiment shown in FIG. 4, the user vote status indicator 1311 displays “You have not yet voted on this Claim.” When a user has voted on the active Point 1140 the user vote status indicator 1311 will display the text string “You have already voted on this Claim” or “You have already voted on this Assumption,” depending on which type of Point is active.

As shown in FIG. 4, the Point cart portion 1320 includes a Point cart title 1321 and lists a series of Points 1322, their associated Point type icons 1323 and rating group 1280, a add/remove button 1326 for adding and removing selected Points, and a show all button 1324 will heighten the Point cart to display all Points it contains. The Point cart portion 1320 is a convenient way to keep track of the selected Points 1322 for later use. When a Point 1322 in the Point cart portion 1320 has been selected, clicking the add/remove button 1326 will remove it from the Point cart portion 1320. When a Point has been selected elsewhere in the argument analysis page or user interface screen 1100 or on some other page or user interface screen, clicking the add/remove button 1326 will add the selected Point 1130 to the Point cart portion 1320. The Point cart portion 1320 remains in the various sidebar portions, which is displayed as part of every page or graphical user interface screen.

As shown in FIG. 4, the competing Points portion 1330 comprises: a list of Points 1332, the title “Competing Points” 1331, the title “Favor” 1334, rating group 1280, total favor 1338, change in favor 1336, a show all button 1333 that will heighten the competing Points portion to display all Points it contains. The total favor 1338 shows the accumulated favor each competing Point has been allotted by voting users. The change in favor 1336 shows how much the total favor of each Point has changed since the user last logged in, or other period of time determined by the administrators of the exemplary embodiment.

The competing Points portion 1330 displays the list of Points that users have identified through voting as having identical logical conclusions. The administrators of the exemplary embodiment can set a threshold percentage of agreement of users necessary for a Point to be included on the competing Points list. For example, to be included on the competing Points list the administrators may choose to require a 60% “yes” vote of the users that vote regarding whether or not the Point in question reaching the same logical conclusion as another Point. The administrators of the exemplary embodiment can set a threshold percentage of agreement of users necessary for a Point to be eligible to replace another Point as a key Point in an argument. For example, to be included on the competing Points list the administrators may choose to require a 75% “yes” vote of the users that vote regarding whether or not the Point in question reaches the same logical conclusion as another Point.

As shown in FIG. 4, the critique quotes portion 1340 contains one or more quotes 1341, their respective authors 1342, and a support indicator 1343 or an opposition indicator 1344 that indicates whether the quote is in support of, or opposition to, respectfully the main Point 1140. When a user is writing a critique 1254, that user will have the ability to highlight a portion of their critique 1254. If their critique 1254 reaches the highest rating either in support of or in opposition to the main Point 1140, their highlighted quote 1341 will appear in the critique quotes portion 13400 of the sidebar portion 1300. The idea behind the critique quotes portion 1340 is to provide a brief, respected, prominent critical reaction (i.e., the critiques quote 1341) from both a supporter and an opponent.

As shown in FIG. 4, the polling portion 1350 can contain one or more of three types of polls, sponsored polls 1352, editorial polls 1354, and user polls 1356. Each type of poll can include one or more questions 1351 and each question 1351 will have two or more related answers 1353. Sponsored polls 1352 identify the source of the poll as being a paying customer. Editorial polls 1354 identify the source of the poll as being an administrator. User polls 1356 identify the source of the poll as being a user. Polls remain in the sidebar portion that is displayed as part of every page or graphic user interface screen, thus offering increased prominence of the poll questions 1352 to the users and the ability to present multiple-choice answers 1352 for each poll question 1352.

FIG. 5 shows one exemplary embodiment of an argument creation graphical page or user interface screen 1020 according to this invention. The argument creation graphical page or user interface comprises three parts: an argument tree creation portion 1400, an argument components creation portion 1500, and a creation sidebar portion 1600.

FIG. 6 shows one exemplary embodiment of the argument tree creation portion 1400. The argument tree creation portion 1400 includes an instance of the argument tree, an instance of the login portion 1110, a title creation portion 1410, a Point replacement portion 1470 and an instance of the logo 1102. Similarly to the argument tree portion 1100, discussed above with regard to FIG. 1-4, the argument tree creation portion 1400 acts as both a graphical representation of the argument structure and as a navigational aid for a user/author as that user creates a new argument.

As shown in FIG. 6, the argument tree 1102 graphically represents the relationship between the Points that are upstream of, and then lead up to, the main Point 1440 of the argument 1440. A number of dependency links 1442 represent the individual key Point dependency connections between the main Point 1440 and its three key Points 1450. The main Point 1440 relies on three first level key Points 1450, which, as illustrated by their dependency links 1542, rely on a number of second level key Points 1460. A second level key Point 1464 is linked by a number of dependency links 1462 to one or more hidden fourth level key Points. These hidden Points can be revealed by selecting the hidden level buttons 1106.

As shown in FIG. 6, the main Point 1440 relies on key Points 1453, 1454, 1455. The first key Point 1453 relies on a first sub-key Point 1463. The third key Point 1455 relies on second sub-key Point 1464, third sub-key Point 1465 and for the sub-key Point 1466. Point 1464 relies on one or more hidden sub-key Points which can be revealed by button 1106.

As shown in FIG. 6, the title creation portion 1410 includes a selectively editable argument title portion 1411, and an instructional reminder portion 1412. The selectively editable title portion 1411, when selected, becomes a selectively editable text field that allow the user to supply and/or edit the name this instance of the argument.

As shown in FIG. 6, the Point replacement portion 1470 includes a title “Point Search” 1471, a search field 1474, a search icon 1475, a search results portion 1472, and a Point replacement button 1473. The Point replacement portion 1470 allows a user to search, select, and replace the active Point 1130 with a selected one of the search resultant or identified Points located by searching through the published Points. The user first selects the Point search field 1474, then enters text or inputs one or more keywords and/or text strings, then selects the search icon to start the search. The search displays the search results in the search results portion 1472. If the search results (i.e. the list of identified published Points) are too numerous to be shown at one time a scrollbar will appear on the right side of the search results portion 1472, allowing the user to access the full results. To replace the active Point with the selected search resultant, the user may do so by first selecting one of the resultant ore identified Points, and then selecting the Point replacement button 1473. All data from the selected resultant or identified Point will be used to populate the data fields of the active Point.

FIG. 7 shows one exemplary embodiment of the argument components creation portion 1500. The argument components creation portion 1500 contains a title editing portion 1510, a key Points portion 1520, a body portion 1540, and a references portion 1560.

As shown in FIG. 7, the title editing portion 1510 functions similarly to the title portion 1210, with three minor differences. First, when selected by the user, the editable title 1513 becomes a text field. Second, when selected by the user, the editable subtitle 1512 becomes a text field. Lastly, when selected by user, the editable concept brief 1516 becomes editable. In contrast, in a typical exemplary embodiment the corresponding elements of the title portion 1210 are neither selectable nor editable.

As shown in FIG. 7, the key Points editing portion 1520 functions similarly to the key Points portion 1220 with two minor differences. First, when selected by the user, the editable key Point concept brief 1521 becomes a text field. Second, a new assumption or claim is added as a new key Point when user/author selects the new key Point claim button 1522 or the new key Point assumption button 1523. It should also be appreciated that before the newly created Points are published, as discussed below, each unpublished Point display its soundness, acceptance and favor ratings without a value, as shown in blank ratings 1584, 1586, 1588 respectively.

As shown in FIG. 7, the body editing portion 1540 functions similarly to the body portion 1240, except that the editable body of text 1542 becomes a text field when selected by the user. Upon creating a new active Point 1455, the editable body of text 1542 may contain instructional text, tips, and a link to support documents 1582 that the user overwrites when entering the user's own text. When a user uses the Point replacement portion 1470 to replace the active Point 1455, the editable body of text 1542 will contain the text from the selected previously created Point, which the user can then edit.

FIG. 8 shows one exemplary embodiment of the creation sidebar portion 1600. The creation sidebar portion 1600 contains a creation details portion 1610, an argument notepad portion 1620, a creation Point cart portion 1630, and an author sharing portion 1640.

As shown in FIG. 8, the creation details portion 1610 contains the creation statistics portion 1615 and primary interaction buttons 1611 and 1613. The creation statistics portion 1615 lists the relevant statistics for the argument 1102 as it is being created by the user, including the current total number of Points 1440 et al. in the argument 1102, the total number of new Points, the date the argument 1102 was created, and the date the argument 1102 was last edited or modified. The creation details portion 1610 includes a publish all Points button 1611 and publish active Point button 1613. When a user selects the publish all Points button 1611, Publishing all previously unpublished Points created by the user as part of that argument 1102. Publishing makes these Points publicly accessible to the users and guests of the client. The registered and verified users are then able to vote on these newly published Points. At the same time, this active argument 1102 is removed from the user's argument notepad portion 1620. The user is then taken to the Point analysis page or graphical interface screen FIG. 1 for the main Point 1440 of the argument 1102. In contrast, when a user selects the publish active button 1613, only the active Point is published, rather than the entire argument. This makes it publicly accessible to the users and guests of the client and can to be voted on by the registered and verified users. This newly published Point remains in the argument 1102 while is in the in argument tree creation portion 1102, as discussed above, but can no longer be edited without becoming an additional new unpublished Point, i.e. like any other previously published Point.

As shown in FIG. 8, the argument notepad portion 1620 includes a list of a series of Points 1622, along with the associated Point type icon 1323 of the main Point of each argument, the “Argument Notepad” title 1621, a delete argument button 1626 for deleting arguments. If the list of Points becomes too numerous to fit in the argument notepad portion 1620 a scroll bar will appear on the right side of the argument notepad portion 1620 allowing all Points to be accessed. An active argument, if any, is highlighted with an active argument indicator 1625. When the argument creation page or graphical user interface screen 1020 shown in FIG. 5 is accessed by the user, typically, the most recently edited argument is initially active. When a user selects another argument in the argument notepad portion 1620, the newly selected argument populates corresponding portions of the argument tree creation portion 1400, the argument components creation portion 1500 and the creation sidebar portion 1600.

As shown in FIG. 8, the creation Point cart portion 1630 functions similarly to the Point cart portion 1320. However, the creation Point cart portion 1630 also includes a replace from cart button 1631. When a Point 1632 listed in the creation Point cart portion 1630, is selected, typically, the user selects the replace from cart button 1631. In response, the active Point in the argument 1102 is replaced by the selected Point 1632. If the user decides to edit the previously created Point, the user can edit it and publish it as a new Point.

As shown in FIG. 8, the author sharing portion 1640 allows users/authors to share read and write access with other users. Under the “Sharing” title portion 1641 of the author sharing portion 1640 includes a write access portion 1643 and read access portion 1644. Each of these portions 1643 and 1644 include lists of authorized users 1645 and 1646, respectively, the users listed in the write portion 1643 have the same permissions and abilities as the argument author. The users listed in the read access portion 1644 can access and read all parts of the argument creation page or graphical user interface 1400 shown in FIG. 5, however these read access users 1646 can not access any of the text editing fields or modifying abilities. If the administrators of a given exemplary embodiment implement a comments system within the argument creation page or graphical user interface, read access users are able to leave comments.

FIG. 9 shows one exemplary embodiment of an argument voting page or graphical user interface screen 1030. The argument voting page or graphical user interface screen 1030 includes a voting portion 1700, an instance of the argument components section 1200, and a voting sidebar portion 1800.

FIG. 10 shows one exemplary embodiment of the voting portion 1700. The voting portion 1700 includes a primary question portion 1720, a competing Points voting portion 1730, a supporting Points voting portion 1740, and an opposing Points voting portion 1750. The voting portion 1700 also contains an instance of the logo 1102, a “Voting Page” title 1711, the title for the Point 1712 that's being voted on, and the author of the Point 1713.

As shown in FIG. 10, a primary question portion 1720 contains a rating type title 1722, a primary question portion 1724, a “Yes” button 1725 and a “No” button 1726. The primary question is the question of greatest concern for each Point type. For a claim, the rating type title 1722 would read “Soundness”, since soundness is the primary rating of a claim. In contrast, for an assumption, the rating type title 1722 would read “Acceptance”, since acceptance is the primary rating of an assumption. The primary portion question 1724 for a claim displays the text “Assuming the Key Points are correct, does this Claim reach a logical conclusion?” as shown in the FIG. 10. In contrast, the primary question portion 1724 for an assumption displays the text “Do you agree with this Assumption?” Throughout the voting portion, the user clicks either the “yes” button 1725 to record their vote in the affirmative, or “no” button 1726, for each question asked.

As shown in FIG. 10, the competing Points portion 1730 includes a “Competing Points” title 1731, the competing Points question 1732, the Point name 1224, the rating group 1280, the “Favor” title 1334, the total favor portion 1338, the change in favor portion 1336, the “Your Favorite” title 1732, the favorite selector 1733, and the “yes” and “no” buttons for each Point. The user may select and/or change which of the competing Points the user prefers using the favorite selector 1733. The competing Points displayed in the competing Points portion 1730 are listed in order of their current total favor, which determines their favor rank. It should be appreciated that, in addition to, or instead of, the favorite selector 1733, which the user uses to assign his or her entire favor vote to one competing Point, various exemplary embodiments could use other systems for determining favor, such as instant run off voting, ranked voting, Condorcet voting, or any other preferential voting system.

As shown in FIG. 10, the supporting Points portion 1740 includes a “Supporting Points” title 1741, a supporting Point question 1742, and a list of supporting Points 1224. Users can identify Points that are not displayed in the supporting Points portion 1740 as supporting the main Point by selecting the add supporting Points button 1744. Users can add Points to their individual supporting Points list by selecting the add supporting Points button 1744, which opens a pop-up dialog window that allows the user to search for a Point and to select it. A Point added to the supporting Points displayed in the supporting Points portion 1740 by a user is not added to a global supporting Points list until that added Point garners a sufficient number of votes which is determined by the administrators of the exemplary embodiment.

As shown in FIG. 10, the opposing Points portion 1750 includes an “Opposing Points” title 1751, an opposing Point question 1752, and a list of opposing Points 1224. Users can identify Points that are no displayed in the opposing Points portion 1750 as opposing the main Point by selecting on the add opposing Points button 1754. Users can add Points to their individual opposing Points list by selecting the add opposing Points button 1754, which opens a pop-up dialog window that allows the user to search for a Point and select it. A Point added to the opposing Points displayed in the opposing Points portion 1750 by a user is not added to a global opposing Points list until that added Point garners a sufficient number of votes, as determined by the administrators of the exemplary embodiment.

It should be appreciated that, in addition to the portions shown within the voting portion 1700, if the administrators of the exemplary embodiment so choose, a portion allowing for the voting of related Points could also be included. The related Points portion would take the same form and minor the sub-portions and functions of the supporting and opposing Point portions, but concerning a list of related Points.

FIG. 11 shows one exemplary embodiment of the voting sidebar portion 1800. The voting sidebar portion 1800 includes an instance of the login portion 1110, an instance of the details portion 1310, and instance of the Point cart portion 1320, an instance of the competing Points portion 1330, an instance of the critique quotes portion 1340, and an instance of the polling portion 1350. The voting sidebar portion also contains a return to main Point button 1812. When selected, the return to main Point button 1812 advances the user to the argument analysis page or graphical use interface screen 1010.

FIG. 12 shows one exemplary embodiment of a user profile page or graphical user interface screen 1040. The user profile page or graphical user interface screen 1040 includes a message portion 1900, a profile components portion 2000, and a voting profile sidebar portion 2100.

FIG. 13 shows one exemplary embodiment of the message portion 1900. The message portion 1900 includes an instance of the logo 1102, the “Welcome back” title 1922, a user name portion 1912 that displays the user's name, a “Since your last login:” title 1921, and an update message portion 1922. The update message portion 1922 is usable to display a variety of information elements relating to Points, platforms, parties, author rating, messages, and any other informational updates concerning the system. In the exemplary embodiment shown, because of an increase in this user's author rating, the first part of the update message portion 1922 describes a community moderation position that the user is now qualified to hold. Additionally, in the exemplary embodiment shown, the update message portion 1922 describes a message updating the user on a change to the user's author rating 1923, the user's new current author rating 1924, a message informing the user the that the user received a message from another user 1925, and includes the avatar of the sender 1926, a message informing the user that the user has received a message 1927 from a party 1929 that the user belongs to, including an icon 1928 identifying the sender of this message as a party.

FIG. 14 shows one exemplary embodiment of the profile components portion 2000. The profile components portion 2000 includes an authored platform portion 2010, a support platform portion 2020, a support party portion 2030, a Points authored portion 2040, a support Points portion 2050 and an oppose Points portion 2060.

As shown in FIG. 14, the authored platform portion 2010 displays a list of platforms that the user has authored and these platforms' associated ratings, as well as a “Platforms You've Authored” title 2011. The support platform portion 2020 displays a list of platforms that the user has supported and these platforms' associated ratings, as well as a “Platforms You Support” title 2021. The platforms 2022 are displayed in the same manner as the Points, with an associated platform icon 2023 “P” that identifies the displayed element as a platform and a unique color. The support party portion 2030 displays a list of parties that the user has joined and the ratings of associated platforms, as well as a “Parties You Support” title 2031. The parties 2032 are displayed in the same manner as Points, with an associated party icon 2033 “Y” that identifies the displayed element as a party and a unique color.

The authored platform portion 2010, the support platform portion 2020 and the support party portion 2030 all share the same metrics: an average soundness value 2091, an average acceptance value 2092, a views number 2093, and a supporters number 2094. The average soundness value 2091 represents the average soundness of the claims in a platform or associated platform of a party. The two numbers relating to average soundness are the total average soundness 2071 and the change in average soundness 2073. The average acceptance value 2092 represents the average acceptance of the assumptions in a platform or associated platform of a party. The two numbers relating to average acceptance are the total average acceptance 2073 and the change in average acceptance 2074. The views number 2093 represents the total number of different users that have viewed the platform or party. The two numbers relating to views are the total views 2075 and the change in views 2076. The supporters number 2094 represents the total number of different users that have endorsed or joined the platform or party in question. The two numbers relating to supporters are the total number of supporters 20737 and the change in supporters 2078.

As shown in FIG. 14, the Points authored portion 2040 displays a list of Points that the user has authored and these Point′ associated ratings, as well as a “Points You've Authored” title 2041. The support Points portion 2050 displays a list of Points that the user supports and these Points' associated ratings, as well as a “Points You Support” title 2051. The oppose Points portion 2060 displays a list of Points that the user opposes and these Points' associated ratings, as well as a “Points You Oppose” title 2061.

The Points authored portion 2040, the support Points portion 2050 and the oppose Points portion 2060 all share the same metrics: a current soundness value 2095, a current acceptance value 2096, a current favor value 2097, a current votes number 2098 and a current views number 2099. The current soundness value 2095 represents the soundness rating of each Point. The two numbers associated with current soundness are the soundness rating of each Point 2080 and the change in soundness value 2081. The current acceptance value 2096 represents the acceptance rating of each Point. The two numbers associated with current acceptance are the acceptance rating of each Point 2082 and the change in acceptance 2083. The current favor value 2097 represents the favor rating of each Point. The two numbers associated with current favor are the favor rating of each Point 2084 and the change in soundness 2085. The current votes number 2098 represents the total number of votes of different users that each Point has accrued. The two numbers associated with current votes are the votes of each Point 2086 and the change in votes 2087. The current views number 2099 represents the total number of different users that have viewed each Point. The two numbers associated with current views are the views of each Point 2088 and the change in views 2089.

FIG. 15 shows one exemplary embodiment of the profile sidebar portion 2100. The sidebar portion comprises three portions: a login portion 1110, a Point cart portion 1320, and a polling portion 1350. The profile sidebar portion also displays the author rating 2112, the change in author rating 2113, and the title “Author Rating” 2111.

FIG. 16 shows one exemplary embodiment of an author rating graphical user interface screen 1050. The author rating page or graphical user interface screen 1050 includes a message portion 1900, an author rating portion 2200, and a profile sidebar portion 2100.

FIG. 17 shows one exemplary embodiment of the author rating portion 2200. The author rating portion 2220 includes an author rating details portion 2220, a flipped votes portion 2230, a picked votes portion 2240, a trending votes portion 2250, a majority votes portion 2260, and a minority votes portion 2270.

As shown in FIG. 17, the rating details portion 2220, which is located below the “Author Rating Details” title 2215, includes two components, an author rating metric portion 2222 and an author rating bonuses portion 2224. The author rating metric portion 2222 displays various measures usable to judge or rate an author, such as the number, percentage, ranking relative to all other users, and other information about the author rating results of the user. The author rating bonuses 2224 displays various actions a given user has done (or hasn't done) that affect the user's author rating. A number of tasks the user has accomplished and/or can accomplish that affect the user's author rating. The administrators of the system may determine that there is sufficient value to certain tasks, such as user training exercises, that users who accomplish those tasks should be rewarded with a bonus to their author rating. Each displayed bonus task 2225 includes a bonus amount indicator 2226 that indicates how the user's author rating score will be affected upon completing that task. A bonus task 2225 can be added to the author rating bonuses portion 2224 when the user initially registers, completes and publishes the user's first argument or completes some other task, reaches some defined milestones, such as number of votes cast, number of Points, arguments, etc. authored and the like. In general, any behavior, action or the like that the administrators of the particular implementation or deployment wishes to reward (or wish to punish by attaching a negative bonus amount to) can be used as a bonus task 2225. Implementing such author rating bonuses is optional.

Every vote on a claim made by the user is analyzed under the “Voting History Point Details” title 2217 is listed in one of those five categories: a flipped votes portion 2230, a picked votes portion 2240, a trending votes portion 2250, a majority votes portion 2260, and a minority votes portion 2270. Under the “Your Score” title 2218, each of those five categories lists the author rating modifier score 2219 of each vote. In various exemplary embodiments, the author rating is determined using a complex analysis based on the votes in each of the five categories. In the exemplary embodiment shown, the score of each vote is used in determining the user's author rating. In the exemplary embodiment shown, each votes score is determined by comparing the state that the claim was in when the user voted on it, relative to the state that claim is currently in.

As shown in FIG. 17, the flipped votes portion 2230 displays a list of claims 2234 and their associated ratings and scores, under the “+6 Scores (flipped in your favor): 6 of 10” label 2232. The “+6” portion of this label 2233 of the title refers to the plus six score earned by each of the votes in the category. The flipped votes portion 2230 lists the claims that the user voted on when the claim was in a state opposite from its current state, and where the user voted for the current state. That is, where the user voted against the then-dominant consensus opinion and was subsequently vindicated. For example, if the given claim was in the “wrong” state when the user reviewed it, and the user believed that the claim's soundness should have the “right” state, the user has at least three choices when determining hot to vote. First, the user could doubt him/her self and lose faith in the user's initial belief that the state of the claim's soundness should be “right”. In response, the use could decide that it was the user's initial belief that was wrong, not the claim's soundness current state, and the user cotes with the majority opinion. Second, the user could decide to wait to see if the claim's soundness switches from the current state to either the “undetermined” state or the other state, and then cast the user's vote. However, neither of these decisions take any courage or leadership to make. By making either of these decisions, the user is not adding the user's voice to the debate in the most useful way.

Thirdly, however, the user could stand firm in the user's belief about this claim's soundness, and vote immediately in accordance with that belief. Only by having some users stand firm and taking the risk in voting against the current consensus opinion will the user population as a whole be able to reverse an early but incorrect consensus opinion. When such a vote is ultimately vindicated, the user who casts such a vote should be rewarded. The “flipped” Points listed in the flipped votes portion 2230, and the bonus points associated with each such Point implement this reward.

Thus, for the given claim above, that claim's soundness was in the “wrong” state when the user voted on it, and never the less this user voted that this claim's soundness was logical. Because, over time and subsequent to this user's opposing vote, the consensus opinion for the claim's soundness switched states, from “wrong” to “right”, this user's vote helped “flip” the state of this claim's soundness. The user will have needed to vote against the majority, and will have had to have and maintained faith that the user's belief about the logic would eventually come to be recognized in and reflected by the majority opinion. As such, that type of vote generates the highest bonus score, which, in this exemplary embodiment, is plus six. The “6 of 10” portion of the title 2232 refers to a component of the analysis that limits the number of times a user can earn certain types of scores that affect the user's author rating. In this exemplary embodiment, the number of times a user can earn bonus points for voting “flips” is limited to 10 claims.

As shown in FIG. 17, the picked votes portion 2240 includes a list of claims 2224 and these claims' associated ratings and scores under the “+3 Scores (successful pick): 16 of 30” label or title 2242. The “+3” of the label or title 2242 refers to the three bonus points score earned for the user's author rating by how and when this user voted for each of the votes claims included in the list 2244. The picked votes portion 2240 lists these claims 2244 that the user voted on when the claims were in the state “undetermined,” and that are currently in the state the user voted for. Unlike the list of “flipped” votes 2234 displayed in the flipped votes portion 2230, the user did not actively vote against an opposing majority consensus. Rather, in this case the user was presented with a choice while blind to the opinion of the majority. Since in the “undetermined” state the soundness rating of a claim is hidden, the claim's soundness could be at 41%, seemingly likely to trend into the “wrong” state, or 59%, seemingly likely to trend into the “right” state, and the user wouldn't have a hint either way. This situation is like a traditional written yes-or-no question test where the test taker can only rely on their own judgment to answer the question. Due to the difficulty to “game” these types of votes users tend vote with a high degree of intellectual honesty in their answers, and thus are reward with a large point bonus. For example, if a given claim's soundness was in the “undetermined” state when the user voted on that claim, and the user voted that this claim's soundness is logical. Because, over time and subsequent to this user's vote, the consensus opinion for the claim's soundness ultimately coalesced on the “right” state, then that user's vote helped pick the winning judgment. Since the current vote for claims in the “undetermined” state is hidden, the user will have needed to vote with only their own judgment to guide them. As such, that type of vote generates the second highest bonus score, which, in this exemplary embodiment, is plus three. The “16 of 30” portion of the title 2242 refers to a component of the analysis that limits the number of times certain types of scores that can affect the user's author rating. In the exemplary embodiment shown, the number of times a user can earn bonus points for voting “picks” is limited to 30 claims.

As shown in FIG. 17, the trending votes portion 2250 includes a list of claims 2254 and those claim's associated ratings and scores, under the “+2 Scores (trending in your favor): 2 of 20” title 2252. The “+2” of the title 2252 refers to the two bonus points earned for the user's author rating by how and when this user voted for each of the claims included in that list 2254. The trending votes portion 2250 lists those claims 2254 that the user voted on when they were in a state opposite of their vote, and the claim has since moved to the state “undetermined.” For example, if the claim was in the state of “wrong” when the user voted on it, and the user voted that is was logical, if over time the claim switched states to “undetermined,” half way toward the users vote, that user's vote helped the claim “trend” toward their judgment. The user would have needed to vote against the majority, and have faith that their logic would eventually come to be recognized. As such, that type of vote would generate the third highest score, plus two. The “2 of 20” in the title 2252 refers to a component of the algorithm that limits the number of certain types of scores that can affect the user's author rating. In the exemplary embodiment shown, the number of times a user can earn bonus points for voting “trending” is limited to 20 claims. It should be appreciated that if the state of a claim appearing in the list of claims 2252 of the trending votes portion 2250 subsequently changes to the state the user voted for, the claim moves from the list 2250 to the flipped votes list 2232. In contrast, if the state of that claim changes back to the state the user didn't vote for (i.e. voted against) the claim merely drops off the list 2252 and the user loses the corresponding two bonus points.

As shown in FIG. 17, the majority votes portion 2260, includes a list of claims 2264 and these claim's associated ratings and scores, under the “+1 Scores (agreed with the majority): 50 of 50” title 2262. The “+1” of the title 2262 refers to the plus one bonus point earned by each of the votes in the category. The majority votes portion 2260 lists those claims 2262 that the user voted on when those claims state that the user voted for and are currently in that state. For example, if a given claim's soundness was in the “wrong” state when the user voted on it, and the user voted that this claim's soundness was illogical, the user agreed with the majority. Additionally, whether or not there have been any subsequent changes to the state of this claim's soundness, that majority judgment currently stands. Since the user had the benefit of the majority judgment when the user voted, there was little risk to the user in casting that vote. As such, that type of vote generates the second lowest bonus score, which in this embodiment, is plus one. The “50 of 50” in the title 2262 refers to a component of the analysis that limits the number of times a user can earn certain types of scores that affect the user's author rating. In the exemplary embodiment shown, the number of times a user can earn bonus points for voting with the majority is limited to 50 claims. This prevents large numbers of votes that merely side with the majority opinion to increase the user's author rating.

As shown in FIG. 17, the minority votes portion 2270 includes a list of claims and their associated ratings and scores, under the title “−1 Scores (disagreed with the majority): 24 of infinite” 2272. The “−1” of the title refers to the minus one score earned by each of the votes in the category. The minority votes portion 2260 lists claims where the user voted against the current state, regardless of the state of the claim at the time of the vote. For example, if the user voted that is was illogical, and the current state is “right” the user has disagreed with the majority. As such, that type of vote would generate the lowest score, minus one. The “24 of infinite” in the title 2272 refers to a component of the algorithm that limits the number of certain types of scores that can affect the user's author rating. In the exemplary embodiment shown, there is a no limit to the ability of “minority” votes to decrease the user's author rating.

It should be appreciated that in the exemplary embodiment shown, the limits to the amount that each vote type can affect the user's author rating is governed by percentages of their total votes allotted to each vote type. For example, the maximum percentage of total votes that can count toward “majority”, “+1” votes, is equal to 40%. If the user has voted on 125 claim's soundness, then at most the ability to affect the user's author rating by “majority” votes is limited to 50 such votes.

It should be appreciated that in the exemplary embodiment shown, some of the text strings suggest that the exemplary user has voted on far more claims than are displayed in their respective lists. The lists have been graphically truncated to fit this printed format. Administrators could use scroll bars, larger pages or graphic user interface screen or any other know or unknown or later-developed feature.

FIG. 18 is a flowchart outlining one exemplary embodiment of a process for creating arguments according to this invention. As shown in FIG. 18, beginning with step S100, operation continues to step S110, where a new argument is created in an argument creation graphical user interface screen 1020 with one assumption as the active, main point 1440. Operation continues to step S120, where the user decides whether or not to use a previously published Point as a template for the active Point by using the Point replacement portion 1470 or creation Point cart portion 1630 functionalities.

If the user does not desire to use a previously published Point as a template, operation continues to step S130. If the user desires to use a previously published Point as a template operation continues to step S150, at which point the user selects the previously published Point. Once selected, operation continues to step S160, which causes the data fields from the selected previously published Point to populate within the fields of the active Point. This transfer of data includes transference of all linked key Points. Operation continues to step S130 where the user is then free to modify, input, or otherwise change the active Point.

Once any sufficient, necessary and/or desired changes and/or inputs, if any, have been made, operation continues to step S140, where the user decides whether or not the active Point needs an initial or an additional key Point. If the user decides the active Point doesn't need any additional key Points, or even an initial key Point, operation continues to step S200. If the user desires to add an initial or an additional key Point to the active Point, operation continues to step S170. If the active Point is an assumption, operation continues to step S180, which causes the active Point to become a claim. Otherwise, operation continues to step S190, which causes a new key Point to be added to the active Point. When the new (initial or additional) key Point has been added to the active Point, operation continues to step S140.

When the user determines that the active Point has sufficient key Points, operation continues from step S140 to step S200, where the user determines whether or not to make another Point the active Point. If the user desires to make another Point the active Point, operation continues to step S210, where the user selects one of the other Points within the argument creation graphical user interface screen 1020, which then becomes the active Point. Once a Point becomes active, operation returns to step S120.

If, at step S200, the user does not desire to change the active Point, the user then publishes either the active Point, using a publish active point button 1613, or publishes all of the Points within the argument creation graphical user interface screen 1020, using the publish all points button 1611 on the creation sidebar portion 1600. Operation continues to step S230, which causes the Point(s) to become publicly accessible to the users and guests. At the same time, this causes the active argument 1102 to be removed from the user's argument notepad portion 1620. Operation continues to step S240, where operation of the process for creating arguments stops. In response, in various exemplary embodiments, the user is taken to the Point analysis page or graphical interface screen shown in FIG. 1 for the main Point 1440 of the argument 1102. However, depending on the particular implementation or deployment, the user can be taken to any one of the screens 1010-1050 discussed above.

FIG. 19 is a flowchart outlining one exemplary embodiment of a process for determining and updating a user's author rating according to this invention. As shown in FIG. 19, beginning with step S300, operation continues to step S310, which causes each non-assumption vote by the user to be accessed and recalled. Operating continues to step S320, where the majority consensus opinion of each non-assumption vote is compared to the votes made by the user on the same particular Points. Operation continues to step S330, where the user and majority votes are compared and analyzed, potentially considering factors such as state at the time of the vote, total number of votes by the user, and other factors. Operation continues to step S340, where the user's author rating is adjusted according to the results of the comparison analysis. Once complete, operation of the process for determining and updating a user's author rating terminates at step S340.

FIG. 20 is a flowchart outlining one exemplary embodiment of a process for determining if a key Point should be switched with another Point according to this invention. As shown in FIG. 20, beginning with step S400, operation continues to step S410, which causes the original Point, for the particular key Point slot in question, to be recalled, along with the current Point for that particular key Point slot if the current Point is not the original Point. Once the original Point has been recalled, operation continues to step S420. If the original key Point does not have any competing Points, operation continues to step S450. If the original key Point does have one or more competing Points, operation continues to step S440, where the Point with the highest favor (which may be the original key Point if the original key Point is not the current key Point) replaces the current key Point in the original key Point slot. If the current key Point has the highest favor, it remains in the slot. When the correct key Point has been determined to be in the key Point slot, operation continues to step S450, which causes one of the remaining unanalyzed key Points to be selected and operation continues to step S420. If there are no remaining unanalyzed key Points, operation of the process for determining if a key Point should be switched with another Point terminates at step S470.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A method for visualizing an argument on a display device, comprising:
dividing the argument into a plurality of points, comprising a main claim point, at least two assumption points and zero, one or more secondary claims points, each one of the plurality of points representing a conceptual portion of the argument;
generating, for each of the plurality of points, a text string that expresses the conceptual portion of the argument represented by that point;
displaying, for each of the plurality of points, a visual representation of that point on the display device, the visual representation of that point including the text string that expresses the conceptual portion of the argument represented by that point,
displaying on the display device a plurality of links between the plurality of visual representations displayed on the display device, each link directly connecting the visual representations of a pair of the plurality of points, each link indicating that the conceptual portion of the argument represented by the point represented by a downstream one of the pair of visual representations logically depends on the conceptual portion of the argument represented by the point represented by an upstream one of the pair of visual representations;
arranging the plurality of visual representations and the plurality of links into a tree structure, the visual representations for each of the at least two assumptions and for each of the number of secondary claim points at least indirectly linked to the visual representation for the main claim point by the plurality of links, wherein:
the visual representation for the main claim point forms a root node of the tree structure,
the visual representations for each of the at least two assumptions define terminal leaf nodes of the tree structure,
for each of the at least two assumption points, the visual representation for that assumption point is one of directly connected to the visual representation for the main claim point by one of the links or indirectly connected to the visual representation for the main claim point by at least two of the links and the visual representation for at least one of the number of secondary claim points;
for each of the main claim point and each of the number of secondary claim points, links directly connect the visual representations for at least two key points to the visual representation for that claim point, each key point being one of one of the at least two assumption points and one of the number of secondary claim points, and
the tree structure represents a series of logical conclusions drawn from the at least two assumption points and the number of secondary claim points that results in the main claim point.

2. A method, using a client device, for interactively creating an argument visualization, supplying the argument visualization to a server and for displaying the argument visualization on a display device of the client device, comprising:
sending a request for a web page implementing an argument creating interface from the client device to a server that stores at least one of the requested web page and created arguments;
receiving the requested web page from the server;
displaying the argument creating interface on the display device;
interacting with the argument creating interface using the client device to create a new point of the argument visualization, each point of the argument visualization including at least a point title text string, a concept text string, an acceptance data field and a favor data field, comprising:
instructing the argument creating interface to create the new point of the argument visualization, the argument creating interface creating a visual representation for the new point;
supplying the point title text string for the new point of the argument visualization using the argument creating interface, and
supplying the concept text string for the new point of the argument visualization using the argument creating interface;
sending, in response to creating the new point of the argument visualization, a message to the server, the message indicating the creation of the new point and containing at least the point title text string and the concept text string for the new point;
displaying the visual representation for the new point within the argument creating interface, the visual representation for the new point including at least the point title text string, the acceptance data field and the favor data field of the new point;
repeating the point interacting, point sending and point displaying steps to add an additional new point to the argument visualization;
interacting with the argument creating interface to create a new link of the argument visualization, each link of the argument visualization connecting a pair of the points of the argument visualization, comprising:
indicating a first one of the points of the argument visualization using the argument creating interface,
indicating a second one of the points of the argument visualization using the argument creating interface, and
instructing the argument creating interface to create the new link between the first and second indicated points, the argument creating interface creating a visual representation for the new link;
sending, in response to creating the new link using the argument creating interface, a message to the server, the message indicating the creation of the new link and identifying the first and second indicated points linked by the new link
displaying the visual representation for the new link within the argument creating interface, the visual representation for the new link extending between and connecting the visual representations for the first and second indicated points linked by the new link;
repeating the link interacting, link sending and link displaying steps to add an additional new link to the argument visualization; and
selectively repeating the point repeating step or the link repeating step, respectively, for each desired additional point to be added to the argument visualization and for each desired additional link to be added to the argument visualization.

3. A method, using a server device, for storing an argument visualization, supplying the argument visualization to a client and for collecting and maintaining user interaction data for the argument visualization, comprising:
receiving a request from a client device for at least one of a web page implementing an argument creating interface and an argument visualization for an argument indicated in the request;
sending the at least one of the requested web page and the argument visualization for the indicated argument to the client;
receiving a message from the client, the message including one of at least:
user interaction data related to at least one point of the indicated argument,
information about a newly created point for an indicated argument, and
information about a newly created link for the indicated argument;
in response to receiving a message that includes user interaction data for at least one point of the indicated argument, extracting the user interaction data from the message,
identifying the at least one point the user interaction data relates to,
accessing at least one stored record for the at least one identified point,
updating the at least one stored record based on the received user interaction data, and
sending updated information from the at least one updated record to the client;
in response to receiving a message that includes information about a newly created point or a newly created link for the indicated argument, determining if the indicated argument exists,
creating at least one new stored record for the indicated argument if the indicated argument does not exist,
creating at least one new stored record for the newly created point or link based on the information about that newly created point or link,
updating at least one stored record for the indicated argument based on creating the at least one new record and on the information about the newly created point or link, and
if the message included information about a newly created link, updating at least one stored record for at least one existing point connected to the newly created link based on the information about the newly created link.
